(19) United States
(12) Patent Application Publication
(10) Pub. No.: US 2011/0155683 A1
(43) Pub. Date: Jun. 30, 2011

(54) CRANE SPREADER AND METHOD FOR AUTOMATICALLY LANDING THE SAME

(75) Inventors: Soo Hyun KIM, Daejeon (KR); Eun Ho Kim, Daejeon (KR); In Gwun Jang, Daejeon (KR); Yunsub Jung, Daejeon (KR); Hanjong Ju, Daejeon (KR); Yoon Keun Kwak, Daejeon (KR); Byung Man Kwak, Daejeon (KR); Kyung Woon Kwak, Daejeon (KR); Doo Yeol Koh, Daejeon (KR); Sang Jun Yoo, Daejeon (KR); Jung Kim, Daejeon (KR); Yun Sic Hong, Daejeon (KR)

(73) Assignee: KOREA ADVANCED INSTITUTE OF SCIENCE AND TECHNOLOGY, Daejeon (KR)

(21) Appl. No.: 12/969,734

(22) Filed: Dec. 16, 2010

(30) Foreign Application Priority Data
Dec. 24, 2009 (KR) 10-2009-0131323

(51) Int. Cl. B66C 1/42; B66C 23/52

(52) U.S. Cl. 212/307; 294/81.2

(57) ABSTRACT

A crane spreader for use in lifting a container includes an attachment unit, a head block, a frame unit, a position adjustment unit and a fixation unit. The attachment unit detachably attaches the crane spreader to an upper surface of the container. The head block has a pulley connected to a trolley of a crane through a cable and coupled to the attachment unit to restrict a horizontal movement the attachment unit with respect to the head block. The frame unit is supported by the head block to be horizontally movable with respect to the head block, the frame unit being disposed below the head block with a gap therebetween. The position adjustment unit aligns the frame unit with the container by displacing the frame unit with respect to the attachment unit. The fixation unit engages the container with the frame unit.

### FIELD OF THE INVENTION

The present invention relates so a crane spreader and a method for automatically landing the same; and, more specifically, to a crane spreader and an auto landing method which is capable of accurately and quickly landing the crane spreader which is swayed by various external factors.

### BACKGROUND OF THE INVENTION

As the volume of trade between countries or between cities significantly increases, the traffic volume is also increasing. In particular, a traffic volume through a sea route where the shipping cost is low is rapidly increasing. With such a rapid increase of traffic volume, an ultra large vessel such as a 10,000 TEU vessel has emerged, which is capable of loading a large volume of cargo. Furthermore, the scale of a container terminal is gradually increasing enough to berth such an ultra large vessel. Such a container terminal includes a plurality of large cranes installed therein, which are capable of loading and unloading containers on and from an ultra large vessel.

In general, a container crane is equipment for loading and unloading containers between a vessel and a quay. The loading and unloading speed of the container crane is a core factor which determines the maximum cargo processing ability of the entire quay.

FIG. 1 is a schematic view of a conventional container crane which is a facility used for loading and unloading containers. Referring to FIG. 1, the conventional container crane includes a gate-type frame and a trolley T. The gate-type frame including a post P and a beam B is mounted on a chassis D which has a plurality of wheels W. The trolley T lifts a container N while moving on the beam B in a transverse direction.

Such a container crane transfers the container N while being moved in a transverse direction (e.g. forward or backward) by the drive of the wheels W or rotated by the direction change of the wheels W.

Meanwhile, the trolley T includes a spreader S which is engaged with the container N. The spreader S is constructed in such a flexible manner as to be engaged with a variety of containers having different widths and lengths.

FIG. 2 shows that a conventional spreader 20 is transferring a container 10. The spreader 20 includes a body 21 and a telescopic frame 22 which can be expanded and contracted with respect to the body 21. Since the telescopic frame 22 can be expanded and contracted, the length of the telescopic frame 22 may be adjusted to such a proper length as to coincide with the size of the container 10.

Furthermore, the conventional crane controls the longitudinal and transverse positions of the spreader 20 by adjusting the longitudinal and transverse positions of the trolley T, and also controls the rotational position of the spreader 20 by simultaneously or sequentially driving a rotational driving device (M).

Meanwhile, twist locking mechanisms 24 formed at end portions of the telescopic frame 22 are inserted to corner castings 11 formed at four corners of the container 10, thereby preventing the container 10 from rotationally deviating from the spreader 20.

As such, when the telescopic frame 22 is aligned with the container 10, flippers 23 installed at four corners of the telescopic frame 22 are engaged with the corner castings 11 formed at the four corners of the container 10. Then, the container 10 is engaged with the spreader 20.

However, in such a conventional container crane, it is difficult to accurately control the relative position of the spreader with respect to the container, because of external factors in which an anchored container vessel pitches or rolls or the spreader suspended to the trolley sways in the wind.

Conventionally, when aligning a spreader with a container, a crane operator in a control room depends on his eyes. Therefore, when the position of the container or the spreader is swayed by an external factor, it is very difficult to accurately control the relative position therebetween. As a result, it takes a lot of operation time to engage the spreader with the container and the operation efficiency decreases.

In order to solve such a problem, the present applicant has proposed an apparatus and method which attaches a frame unit of a crane spreader to a certain position of the upper surface of a container by using an attachment member, and then moves the frame unit with respect to the attachment member such that the spreader is positioned at the accurate position on the container (refer to Korean Patent Application No. 2009-0074305). This apparatus has a structure that a head block, on which pulleys connected to a trolley through a cable are installed, is fixed to the frame unit. In this structure, the frame unit of the crane spreader is fixed to a proper Position of the upper surface of the container by using the attachment member, and then the frame unit is aligned with a container by adjusting the relative position of the frame unit on the basis of the attachment member. Therefore, although a container vessels pitches or rolls, the crane spreader may be relatively quickly and accurately landed on the container.

In many cases, the position of the container with respect to the head block needs to be precisely controlled even after the container is engaged with the spreader, particularly in a state in which the container is lifted. However, in accordance with the above apparatus in which the head block is fixed so as not to relatively move with respect to the frame unit, there is a problem in that the relative position movement between the head block and the container is impossible after the crane spreader is engaged with the container.

### SUMMARY OF THE INVENTION

The present invention provides an apparatus and method which is capable of precisely adjusting the position of a container with respect to a head block connected to a trolley, after the container is engaged with a crane spreader.

Further, the present invention provides an apparatus and method which is capable of precisely adjusting the position of a spreader with respect to a head hock connected to a trolley, before landing the spreader onto a container.

In accordance with an aspect of the present invention, there is provided a crane spreader for use in lifting a container. The crane spreader includes: an attachment unit for detachably attaching the crane spreader to an upper surface of the container; a head block having a pulley connected to a trolley of a crane through a cable and coupled to the attachment unit to restrict a horizontal movement of the attachment unit with respect to the head block; a frame unit supported by the head block to be horizontally movable with respect to the head block; a position adjustment unit for aligning the frame unit with the container by displacing the frame unit with respect to the attachment unit; and a fixation unit for engaging the container with the frame unit when the frame unit is aligned with the container.

In accordance with the second aspect of the present invention, there is provided a crane spreader for use in lifting a container. The crane spreader includes: a head block having a pulley connected to a trolley of a crane through a cable; a frame unit supported by the head block to be horizontally movable with respect to the head block, the frame unit being disposed below the head block with a gap therebetween; a position adjustment unit, including a center housing, for moving the center housing with respect to the frame unit; and a shaft portion restricting a horizontal movement, of the head block with respect to the center housing.

In accordance with a second aspect of the present invention, there is provided a method for use in landing a crane spreader. The crane spreader includes an attachment unit attached to an upper surface of a container, a head block connected to a trolley through a pulley, and a frame unit being horizontally movable with respect to the attachment and coupled to be horizontally movable with respect to the head block. The method includes: detecting the position of the container; attaching the attachment unit to an upper surface of the detected container; detecting the relative position of the frame unit with respect to the container, and calculating a position movement path of the frame unit on the basis of the attachment unit; aligning the frame unit with the container by moving the frame unit on the basis of the attachment unit along the calculated path; and detaching the attachment unit from the container, and adjusting the relative position of the frame unit with respect to the head block, after aligning the frame unit with the container.

### BRIEF DESCRIPTION OF THE DRAWINGS

The objects and features of the present invention will become apparent from the following description of embodiments given in conjunction with the accompanying drawings, in which:

FIG. 1 is a schematic view of a conventional container crane;

FIG. 2 shows a conventional crane spreader;

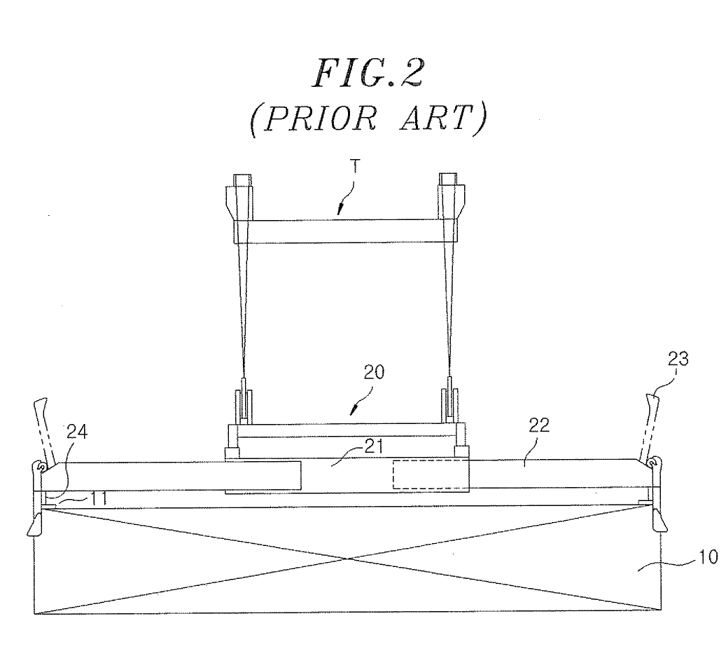

FIG. 3 is a front view of a crane spreader in accordance with an embodiment of the present invention;

FIG. 4 is a perspective view of the crane spreader in accordance with the embodiment of the present invention;

FIG. 5 is a plan view illustrating a position adjustment unit of the crane spreader in accordance with the embodiment of the present invention;

FIG. 6 illustrates a state in which the crane spreader in accordance with the embodiment of the present invention is not aligned with a container;

FIG. 7 depicts a state in which the crane spreader in accordance with the embodiment of the present invention is aligned with a container;

FIG. 8 shows a state in which a head block is relatively moved with respect to the container after the crane spreader is engaged with the container; and

FIG. 9 presents a state in which a frame unit is relatively moved with respect to the head block after the crane spreader is engaged with the container.

### DETAILED DESCRIPTION OF THE EMBODIMENTS

Hereinafter, embodiments of the present invention will be described in detail with reference to the accompanying drawings so that they can be readily implemented by those skilled in the art.

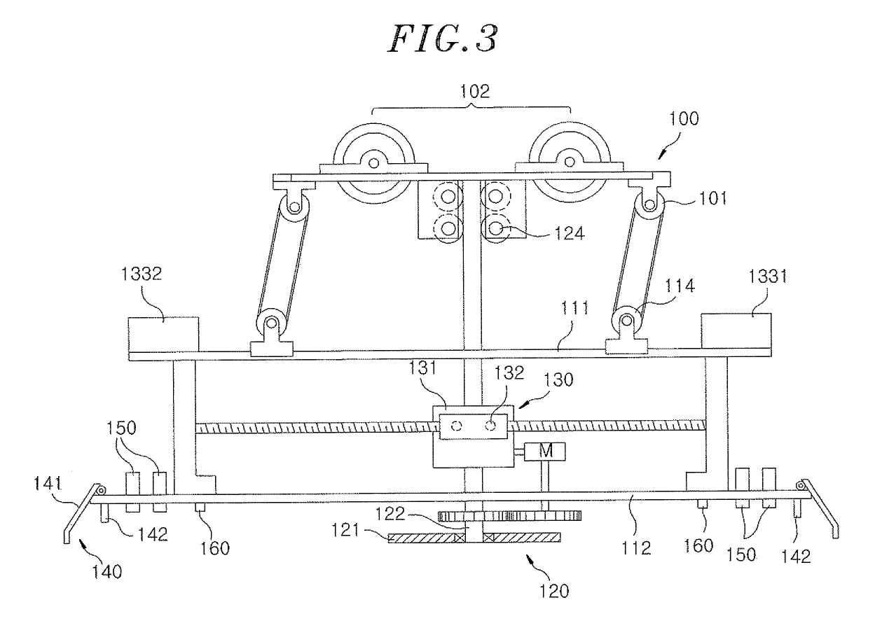

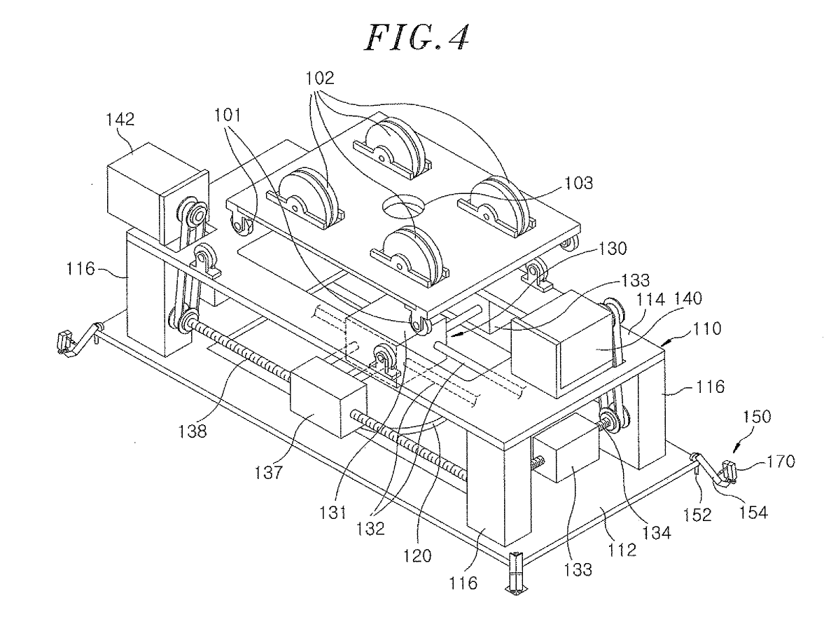

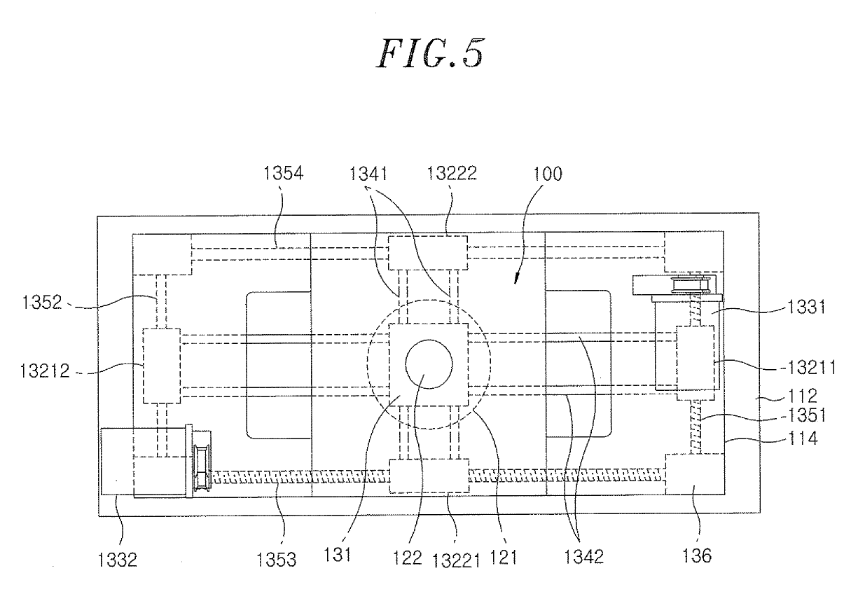

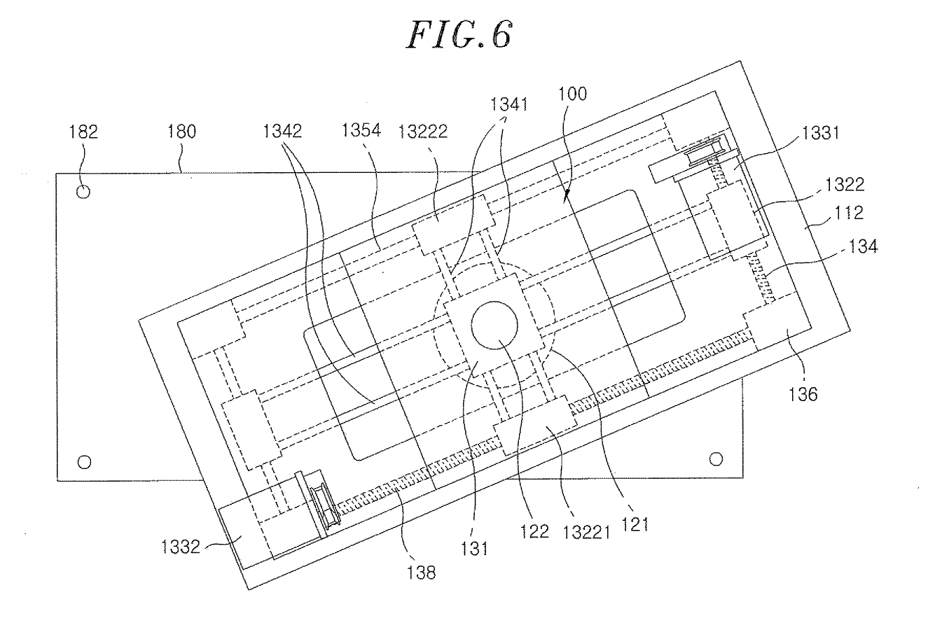

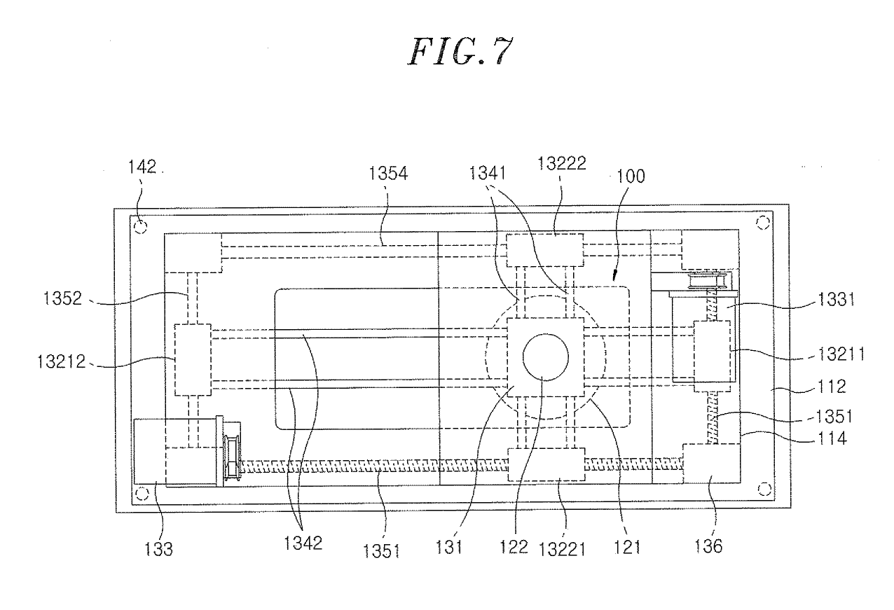

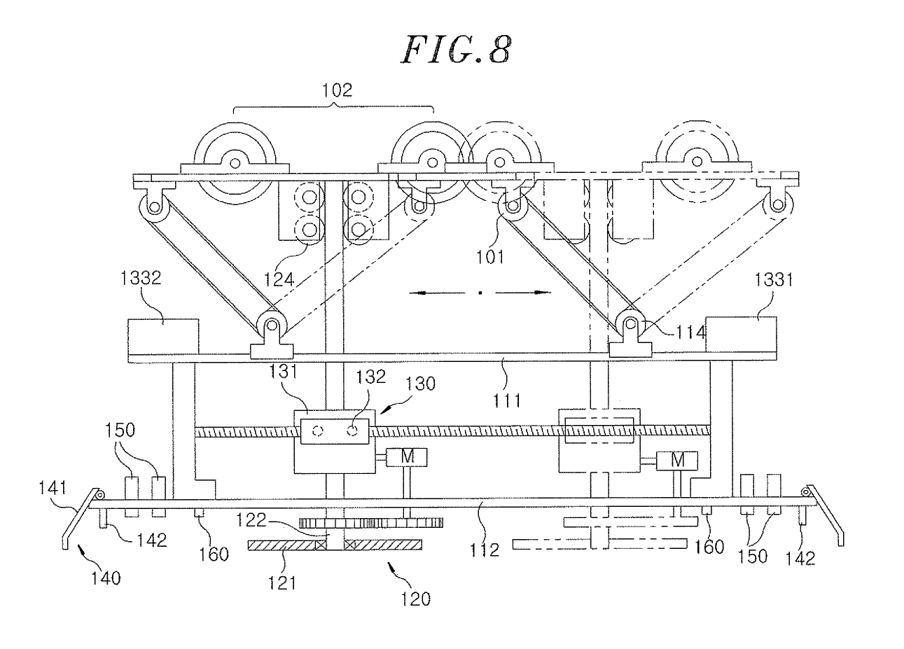

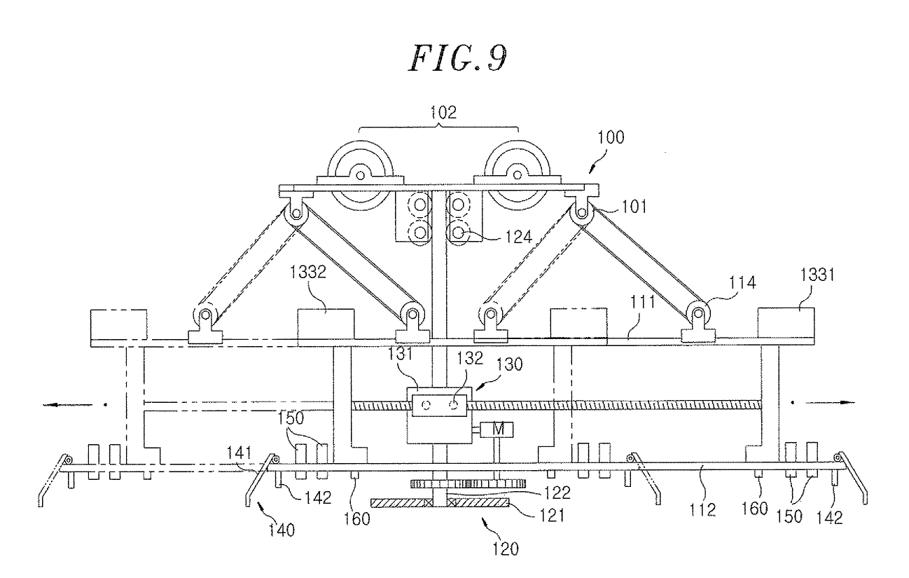

FIG. 3 is a front view of a crane spreader in accordance with an embodiment of the present invention. FIG. 4 is a perspective view of the crane spreader of FIG. 3. FIG. 5 is a plan view illustrating a position adjustment unit of the crane spreader. FIGS. 6 and 7 are plan views illustrating a process in which the crane spreader in accordance with the embodiment of the present invention is aligned with a container. FIG. 8 is a diagram illustrating a state in which a head block is relatively moved with respect to the container after the crane spreader is coupled to the container. FIG. 9 is a diagram illustrating a state in which a frame unit is relatively moved with respect to the head block after the crane spreader is coupled to the container.

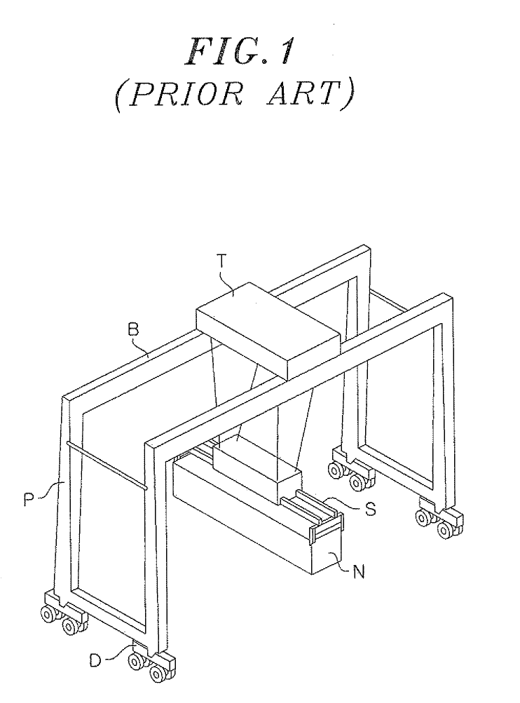

Referring to FIGS. 3 and 4, the crane spreader 20 in accordance with the embodiment of the present invention includes a head block 100, a frame unit 110, and an adhesion unit 120. Through a cable (not shown), the head block 100 is connected to and supported by a trolley (refer to FIG. 1). The frame unit 110 is supported by the head block 100. The attachment unit 120 is disposed to pass through the head block 100 and the frame unit 110 and attached to the upper surface of a container.

The head block 100 is connected to the trolley by the cable, and the cable hanging down from the trolley is wound halfway around a head pulley 102 installed in the head block 100, and then goes back to the trolley. A driving motor winds up this cable, thereby lifting the spreader 20 (including the head block 100).

Support pulleys 101 for holding the frame unit 110 are installed under the head block 100. The support pulleys 101 support support pulleys 114 installed at corresponding positions on the frame unit 110, through a wire. Between the head block 100 and the frame unit 110, four pairs of support pulleys 101 and 114 may be installed at four corners of the head block 100 and at the corresponding positions on the frame unit 110, respectively, in order to stably support the frame unit 110. As such, since the head block 110 is supported by the plural pairs of support pulleys 101 and 114 and wires connecting between the support pulleys 101 and 104, the frame unit 110 may be relatively moved in a direction parallel to the surface of the head block 100.

In this embodiment, it has been described that the head block 100 supports the frame unit 110 by using the support pulleys 101 and 114 and the wires. However, the frame unit 110 may be supported by chains, formed of a metallic material or other materials capable of providing a reasonable strength, and support portions for supporting the chains, which are formed on each of the head block 100 and the frame unit 110. Such a structure is also included in the scope of the present invention.

The head block 100 has a through-hole 103 formed in the center thereof, through which a shaft portion 122 of the attachment unit 120 passes. Under the through-hole 103, support rollers 124 are provided in four directions along the circumference of the through-hole 103. The support rollers 124 support the shaft 122 so as to move in the axial direction. The through-hole 103 is formed to have a slightly larger diameter than the diameter of the shaft 122, and the support rollers 124 guide the shaft 122 in a direction perpendicular to the head block 100. Therefore, the shaft 122 may vertically move within the through-hole without being contacted with the through-hole. At this time, the plurality of support rollers 124 may be continuously formed in the direction perpendicular to the head block 100 such that the shaft 122 may be stably guided in the direction perpendicular to the head block 100.

Next, the frame unit 110 will be described. The frame unit 110 includes an upper frame 111, a lower frame 112, and supports 113. The upper frame 111 forms an upper plate of the frame unit 110. The lower frame 112 is formed in parallel to the upper frame 111 and forms a lower plate of the frame unit 110. The supports 113 intervene between the upper and lower frames 111 and 112 such that constant distance therebetween is maintained. The upper frame 111 includes the support pulleys 114 which are supported by the support pulleys 101 of the head block 100 through the wires. The lower surface of the lower frame 111 faces a container 180 (refer to FIG. 6). In this embodiment, it has been described that the lower frame 112 is a plate. However, the lower frame 112 may be a telescopic frame which may be expanded and contracted according to the size of the container 180.

The lower frame 112 includes a proximity sensor 150 and a vision camera 160 provided on the lower surface thereof. The proximity sensor 150 may sense whether or not a container is positioned in proximity to the lower frame 112, and the vision camera 160 may detect the position of the container 180 by imaging a corner portion of the container 180. Furthermore, the lower frame 112 includes fixation units 140 formed at four corners thereof, and the fixation units 140 are rotationally coupled to four corners of the container 180. When the spreader is lowered by the trolley, the approximate position of the container 180 is first detected by the vision camera 160. Based on the detection result, the position of the spreader is adjusted. After the spreader approaches the proximity of the container 180, the proximity sensor 150 is used to detect whether the four corners of the container 180 is positioned in proximity to the proximity sensor. A process in which the position adjustment unit 130 is used to adjust the position of the frame unit 110, based on the detection result of the proximity sensor 150, will be described in connection with the position adjustment unit 130 which will be described below.

Next, the attachment unit 120 will be described. The attachment unit 120 includes an attachment portion 121 and a shaft portion 122. The attachment portion 121 is attached and fixed to the upper surface of the container, and the shaft portion 122 supports the attachment portion 121, passes through a center housing 131 of the position adjustment unit 130 which will be described below, and extends to the through-hole 103 of the head block 100.

The attachment portion 121 may be formed of a magnet which may be attached to the upper surface of the container N formed of a metallic material by a magnetic force. Alternatively, the attachment portion 121 may be formed of a rubber absorption plate which may be attached by an adsorption force. Furthermore, when the attachment unit 120 is constructed by using a proper material having predetermined weight or more, it is possible to expect such an effect that the attachment portion 121 is substantially attached and fixed to the upper surface of the container by a frictional force which is generated by the weight of the attachment unit 120.

The shaft portion 122 may be formed in such a cylindrical shape as to rotatably support the attachment portion 121 with respect to the spreader S. The attachment portion 121 is fixed to the lower end of the shaft portion 122. The shaft portion 122 passes through the center housing 131 of the position adjustment unit 130. Therefore, when the center housing 131 is relatively moved with respect to the frame unit 110 by first and second horizontal movement portions of the position adjustment unit 130, the shaft portion 122 is also relatively moved with respect to the frame unit 110 along the center housing 131.

Furthermore, the shaft portion 122 extends to the through-hole 130 of the head block 100. The plurality of support, rollers 124 are fixed to the lower surface of the head block 100 along the circumference of the through-hole 103 through a jig. In such a structure, a vertical movement of the shaft 122 with respect to the head block 100 is allowed, but a horizontal movement thereof is limited. As a result, when the shaft portion 122 is relatively moved in the direction parallel to the frame unit 110 by the position adjustment unit 130, the head block 100 confined by the shaft portion 122 is also moved in the parallel direction in the same manner as the shaft portion 122.

When the spreader is positioned in proximity of the container 180, the attachment unit 120 having the above-described structure is advanced toward the upper surface of the container 180 from the spreader, and the attachment portion 121 of the attachment unit 120 is attached on the upper surface of the container 180. The attachment portion 121 is substantially attached and fixed to the upper surface of the container 180. Therefore, after the attachment portion 122 is fixed, the relative swaying motion between the spreader and the container 180 is significantly reduced even though the vessel pitches or rolls or the cable is swayed by the wind.

Furthermore, since the attachment portion 121 is attached to the container 180, the position adjustment unit 130 is driven to rotate and horizontally move the frame unit 110 on the basis of the attachment portion 121. Then, the frame unit 110 may be aligned with the container 180.

Finally, the spreader is engaged with the container 180 by the fixation unit 140 which includes a twist locking mechanism 142 and flippers 141. The twist locking mechanism 142 installed on a corner of the lower surface of the frame unit 110 is inserted into the corner casting 182 installed at the corner of the container 180, to thereby prevent from rotationally deviating from the spreader. Then, the flippers 141 are engaged with the four corners of the container 180.

FIG. 5 illustrates the position adjustment unit 130 in accordance with the embodiment of the present invention. The position adjustment unit 130 includes the center housing 131 through which the shaft portion 122 passes, the first and second horizontal movement portions for transferring the center housing 131 in the horizontal direction, first second driving motors 1331 and 1332 for driving the first and second horizontal movement portions, respectively, and a third driving motor M for rotationally driving the shaft portion 122. As illustrated in FIG. 3, the third driving motor M is fixed to the center housing 130. But, the third driving motor M can be also fixed to the head block 100.

The first horizontal movement portion includes a first support rod 1342, a first guide housing 13212, and a first nut housing 13211. The first support rod 1342 passes through the center housing 131 and is installed along the long-axis direction of the frame unit 110. The first guide housing 13212 and the first nut housing 13211 are fixed to both ends of the first support rod 1342 to guide or transfer the first support rod 1342. The first nut housing 13211 is installed on a first screw shaft 1351. As the first screw shaft 1351 rotates in the clockwise or counterclockwise direction, the first nut housing 13211 is moved forward and backward along the short-axis direction of the frame unit 110. When the first nut housing 13211 is moved forward and backward along the short-axis direction of the frame unit 110, the first support rod 1342 fixed to the first nut housing 13211 is also moved forward and backward, and the center housing 131 through which the first support rod 1342 passes performs the same motion. The first guide housing 13212 fixed to an end of the first support rod 1342 guides the first support rod 1342 along a first guide rod 1352.

The second horizontal movement portion includes a second support rod 1341, a second guide housing 13222, and a second nut housing 13221. The second support rod 1341 passes through the center housing 131 and is installed along the short-axis direction of the frame unit 110. The second guide housing 13222 and the second nut housing 13221 are fixed to both ends of the second support rod 1341 to guide or transfer the second support rod 1341. The second nut housing 13221 is installed on a second screw shaft 1353. As the second screw shaft rotates in the clockwise or counterclockwise direction, the second nut housing 13221 is moved left and right along the long-axis direction of the frame unit 110. When the second nut housing 13221 is moved left and right along the long-axis direction, the second support rod 1341 fixed to the second nut housing 13221 is also moved left and right, and the center housing 131 through which the second support rod 1341 passes performs the same motion. The second guide housing 13222 fixed to an end of the second support rod 1341 guides the second support rod 1341 along a second guide rod 1354.

The first and second support rods 1342 and 1341 may form a pair.

The first and second driving motors 1331 and 1332 are connected to the first and second screw shafts 1351 and 1353, respectively, through a belt, and transfer the center housing 131 in the horizontal direction. The third driving motor M is connected to the shaft portion 122 of the attachment unit 120 through a power transmission element such as a gear or belt and rotates the shaft portion 122. When a rotational driving force is applied to the shaft portion 122 after the attachment unit 120 is fixed to the upper surface of the container, the frame 110 is rotated about the attachment unit 120, because the shaft portion 122 is not rotated.

FIGS. 6 and 7 show a process in which the frame unit 110 of the spreader is aligned with the container 180 by the attachment unit 120 and the position adjustment unit 130. FIG. 6 illustrates a situation in which the attachment portion 121 of the attachment unit 120 is attached and fixed to a position which is slightly deviated from the center of the container in a state in which the attachment portion 121 is slightly rotated. At this time, the proximity sensor 150 is used to acquire the relative positional relation of the frame unit 110 with respect to the container 180. Based on the result, a movement path of the frame unit 110 is determined, and the first and second driving motors 1331 and 1332 are driven to move the frame unit 110 to the center of the container. Furthermore, the third driving motor M is driven to rotate the frame unit 110. As such, the proximity sensor 150 is used to detect the position and posture of the frame unit 110, and the first to third driving motors 1331, 1332, and M are driven on the basis of the detection result. Then, the frame unit 110 may be aligned with the container 180.

FIG. 8 depicts a method for precisely controlling the position of the head block 100 by adjusting the relative position between the head block 100 and the frame unit 110 through the position adjustment unit 130. Referring to FIG. 8, when the position adjustment unit 130 is driven in a state in which the horizontal direction movement of the frame unit 110 is restricted, for example, a state in which the spreader is fixed to the container and the container is not yet lifted but placed on the bottom, the frame unit 110 is fixed, but the head block 100 is relatively moved with respect to the frame unit 110. In FIG. 8, a solid line indicates a state in which the head block 100 is moved in the left direction from the center by the position adjustment unit 130, and a dashed dot line indicates a state in which the head block 100 is moved in the right direction from the center by the position adjustment unit 130. In order for the movement of the head block 100, the fixation of the attachment unit 120 to the upper surface of the container needs to be released. Such a horizontal movement of the head block 100 may precisely position the head block 100 at a desired location.

FIG. 8 illustrates a case in which, when the frame unit 110 is fixed, the position adjustment unit 130 is driven to transfer the head block 100. On the other hand, FIG. 9 illustrates a case in which, when the horizontal position of the head block 100 is fixed, for example, when the spreader is lifted by the trolley, the position adjustment unit 130 is driven to move the frame unit 110 in the left and right, direction. As such, when the container is fixed and coupled to the spreader and then lifted by the trolley and the position adjustment unit 130 is driven to minutely adjust the position of the frame unit 110, the position of the container attached to the frame unit 110 may be precisely controlled.

In case that the position adjustment unit 130 is driven before the landing of the spreader onto the container, the position of the frame unit 110 can be minutely adjusted. As a result, the position of the frame unit 110 can be precisely controlled and aligned with the container. Then, the frame unit 110 lands on the container. In accordance with the crane spreader and the method for automatically landing the same, the spreader which is swayed by various external factors on the ground or the sea, for example, a mobile harbor may be quickly and accurately fixed to a container by the attachment unit of the spreader fixed to the container and the position adjustment unit for adjusting the position and posture of the frame unit on the basis of the attachment unit, and then transferred stably.

Further, even after the frame unit is coupled to the container, the head block is relatively moved with respect to the frame unit, or the frame unit is relatively moved with respect to the head block, thereby precisely controlling the position of the container coupled to the frame or the head block.

While the invention has been shown and described with respect to the preferred embodiments, it will be understood by those skilled in the art that various changes and modifications may be made without departing from the scope of the invention as defined in the following claims.

What is claimed is:

1. A crane spreader for use in lifting a container, comprising:
an attachment unit for detachably attaching the crane spreader to an upper surface of the container;
a head block, having a pulley connected to a trolley of a crane through a cable, coupled to the attachment unit to restrict a horizontal movement of the attachment unit with respect to the head block;
a frame unit supported by the head block to be horizontally movable with respect to the head block, the frame unit being disposed below the head block with a gap therebetween;
a position adjustment unit for aligning the frame unit with the container by displacing the frame unit with respect to the attachment unit; and
a fixation unit for engaging the container with the frame unit when the frame unit is aligned with the container.

2. The crane spreader of claim 1, wherein the attachment unit includes an attachment portion attached to the upper surface of the container and a shaft portion for supporting the attachment portion, and
the shaft portion is rotatably supported about the axis of the shaft portion by the head block.

3. The crane spreader of claim 2, wherein the shaft portion is supported axially movably by a plurality of rollers installed in the head block.

4. The crane spreader of claim 2, wherein the attachment portion includes an attachment plate made of a magnet or a rubber.

5. The crane spreader of claim 1, wherein the frame unit is supported by the head block through a wire.

6. The crane spreader of claim 1, wherein the position adjustment unit includes:
a center housing through which the shaft portion of the attachment unit passes;
a first horizontal movement portion connected to the center housing and moving the frame unit in a long-axis direction of the frame unit; and
a second horizontal movement portion connected to the center housing and moving the frame unit in a short-axis direction of the frame unit.

7. The crane spreader claim 6, wherein the first horizontal movement portion includes:
a first support rod passing through the center housing, installed along the long-axis direction of the frame unit, and coming in sliding contact with the center housing;
a first nut housing installed at one end of the first support rod; and
a first screw shaft for horizontally transferring the first nut housing along the long-axis direction of the frame unit, and
the second horizontal movement portion includes:
a second support rod passing through the center housing, installed along the short-axis direction of the frame, and coming in sliding contact with the center housing;
a second nut housing installed at one end of the second support rod; and
a second screw shaft for horizontally transferring the second nut housing along the short-axis direction of the frame unit.

8. The crane spreader of claim 7, further comprising:
a first driving motor for driving the first screw shaft;
a second driving motor for driving the second screw shaft; and
a third driving motor for rotationally driving the shaft portion of the attachment unit with respect to the center of the shaft portion.

9. The crane spreader of claim 8, wherein the first and second driving motors are driven to horizontally move the frame unit, and the third driving motor is driven to rotationally move the frame unit, thereby aligning the frame unit with the container.

10. The crane spreader of claim 1, wherein the frame unit includes:
a sensor for sensing the position of the container; and
a controller for acquiring the relative position between the frame unit and the container by using information from the sensor.

11. The crane spreader of claim 10, wherein the sensor includes a proximity sensor installed at four corners of the frame units, and
the relative position between the frame unit and the container is detected by using information on whether or not the frame unit is sensed by the proximity sensor.

12. The crane spreader of claim 1, further comprising:
a vision camera installed under the frame unit and detecting the position of the container; and
an image processing unit for processing data of the vision camera.

13. The crane spreader of claim 12, further comprising an actuator for controlling an angle of the vision camera.

14. A crane comprising the crane spreader of claim 1.

15. A ship comprising the crane of claim 14.

16. A crane spreader for use in lifting a container, comprising:
a head block having a pulley connected to a trolley of a crane through a cable;
a frame unit supported by the head block to be horizontally movable with respect to the head block, the frame unit being disposed below the head block with a gap therebetween;
a position adjustment unit, including a center housing, for moving the center housing with respect to the frame unit; and
a shaft portion confining a horizontal movement of the head block with respect to the center housing.

17. The crane spreader of claim 16, wherein the position adjustment unit further includes:
a first horizontal movement portion connected to the center housing and moving the frame unit in a long-axis direction of the frame unit; and
a second horizontal movement portion connected to the center housing and moving the frame unit in a short-axis direction of the frame unit,
wherein the shaft portion passes through the center housing.

18. A method for use in landing a crane spreader, the crane spreader including an attachment unit attached to an upper surface of a container, a head block connected to a trolley through a pulley, and a frame unit being horizontally movable with respect to the attachment and coupled to be horizontally movable with regard to the head block, the method comprising:
detecting the position of the container;
attaching the attachment unit to an upper surface of the detected container;
detecting the relative position of the frame unit with respect to the container, and calculating a position movement path of the frame unit with respect to the attachment unit;
aligning the frame unit with the container by moving the frame unit with respect to the attachment unit along the calculated path; and
detaching the attachment unit from the container, and adjusting the relative position between the head block and the frame unit after aligning the frame unit with the container.

19. The method of claim 16, wherein the adjusting of the relative position between the head block and the frame unit is performed after the container is lifted from the ground, in order to adjust the absolute position of the frame unit.

20. The method of claim 16, wherein the adjusting of the relative position between the head block and the frame unit is performed before the container is lifted from the ground, in order to adjust the relative position of the head block with respect to the frame unit.
